(19) United States
(12) Patent Application Publication
(10) Pub. No.: US 2006/0096193 A1
(43) Pub. Date: May 11, 2006

(54) Extrusion profile

(76) Inventor: Rolf J. Ohrstrom, Toronto (CA)

Correspondence Address: BERESKIN AND PARR, 40 KING STREET WEST, BOX 401, TORONTO, ON, M5H 3Y2, CA

(21) Appl. No.: 11/256,199

(22) Filed: Oct. 24, 2005

Related U.S. Application Data
(60) Provisional application No. 60/621,027, filed on Oct. 22, 2004.
(60) Provisional application No. 60/621,032, filed on Oct. 22, 2004.

(51) Int. Cl. E06B 3/00

(52) U.S. Cl. 52/204.5

(57) ABSTRACT

An extrusion profile has internal support structures in the form of walls that are configured with respect to each other to form a generally triangular shape in cross-section. The extrusion profile can have exterior walls enclosing a generally polygonal interior space, and interior walls extending from inner surfaces of the exterior walls. The interior walls can cooperate with each other and/or with the exterior walls to form the generally triangular support structures. The support structures can increase the load bearing capacity of the extrusion profile both during manufacture, to improve product quality and/or processing speed, and during post-manufacture use of the extrusion.

This application claims the benefit under 35 USC 119(e) of U.S. Provisional Application Nos. 60/621,027, filed on Oct. 22, 2004, and 60/621,032, filed on Oct. 22, 2004, the entire contents of which are hereby incorporated by reference.

### FIELD OF THE INVENTION

The present invention relates to support structures for extruded profiles. More particularly, this invention relates to extruded profiles having triangular support structures.

### BACKGROUND OF THE INVENTION

Extruded lengths of plastic profiles can provide low cost structural elements useful in applications including, for example, but not limited to, window frame members. Extruded profiles often are of a generally hollow, tubular design, having an outer surface defined by adjoining exterior wall portions that form, in cross-section, a generally enclosed polygonal interior space. The interior space is bounded by inner surfaces of the exterior wall portions, opposite the outer surface. Hidden within the generally enclosed interior space, some known extruded profiles have interior walls extending from the inner surfaces of one or more of the exterior walls. The interior walls can cooperate with each other and with the exterior wall portions to form internal structures within the extruded profile. The internal structures can provide screw bosses for anchoring screws used to fasten hardware, or other extruded profiles or elements, to the lengths of the known extruded profile.

The interior walls of known extruded profiles are typically substantially orthogonal to the inner surfaces of exterior walls, forming inernal structures that are generally rectangular in cross-section. Small square internal structures are provided in known designs to serve as screw bosses. Screw boss designs having a generally circular shape in cross-section are also known in the prior art.

### SUMMARY OF THE INVENTION

According to one aspect of the present invention, a generally triangular internal support structure is provided for an extrusion profile. The triangular support structure, in one embodiment, has three walls that, in cross-section, are connected to each other to form a generally triangular shape. The support structure can be provided within an internal hollow of an extruded profile, such as, for example, but not limited to, a window frame lineal.

In some embodiments, the triangular support structure is adapted to increase the strength and rigidity of an extrusion profile in which the triangular support structure is provided. The triangular support structure can also be adapted to serve as a screw boss for anchoring screws. The screws can be installed parallel with a longitudinal axis (i.e. the direction in which the profile is extruded) of the support structure, and screwed into an exposed longitudinal end of the support structure. Screws can also be installed through one or more walls of the triangular support structure, at a generally transverse or oblique angle relative to a longitudinal axis of the support structure.

The triangular support structure can better distribute distortional forces applied to the support structure. Such distortional forces can include, for example, forces applied to the support structure during an extrusion process for manufacturing the support structure, such as thermal forces generated by non-uniform cooling of the support structure causing internal stress loads. Distortional forces can also include the force of gravity acting on the walls of the support structure when in a semi-sold state, after the support structure has exited a forming die but before the support structure has cooled to a generally solid state.

As well, distortional forces can be exerted on the support structure during post-manufacturing use of the support structure, for example, by screw fasteners anchored in the support structure and used to secure elements to the support structure or to an extrusion provided with the support structure. The improved resistance to distortional forces can provide a more accurate extruded profile, fewer product non-conformity rejections, and faster extrusion speeds, and a stronger anchor for screw fasteners.

The triangular support structure need not be a true triangle with three rectilinear intersecting walls, but can have a modified triangular shape, such as, for example, but not limited to, a truncated triangle or trapezoidal configuration. The triangular support structure can have, but need not have, three acute enclosed angles, or two acute and one obtuse enclosed angle between intersecting walls. A support structure having a generally right angled triangle configuration is also contemplated by the present invention.

According to another aspect of the present invention, an extrusion profile is provided with integral support structures that are generally triangular in cross-section. The extrusion profile can have exterior walls enclosing a generally polygonal interior space, and interior walls extending from inner surfaces of the exterior walls. The interior walls can cooperate with each other and/or with the exterior walls to form the generally triangular support structures.

According to another aspect of the invention, a method of reinforcing an extrusion profile is provided. In one embodiment, the method includes the step of providing an extrusion profile with three walls that are configured to form a support structure having a generally triangular shape in cross-section. The triangular support structure can be provided within an extrusion profile having exterior walls, and can be extruded simultaneously with the exterior walls. One or more walls of the triangular support structure can be part of the exterior walls. One or more of the support walls can be part of a network of interior walls extending from interior surfaces of the exterior walls of the extrusion profile.

According to another aspect of the present invention, a die and a method of manufacturing an extruded profile using the die is provided. The die has a plurality of extrusion slots including peripheral slots for forming external walls of the profile, and one or more internal slots for forming interior walls of the profile. The internal slots are configured, relative to each other and/or to the external slots, in a generally triangular configuration. To manufacture the profile, semi-liquid material is extruded through the slots of the die, so that a generally triangular support structure is provided in the as-extruded profile.

### BRIEF DESCRIPTION OF THE DRAWINGS

For a better understanding of the present invention and to show more clearly how it would be carried into effect, reference will now be made by way of example, to the accompanying drawings that show a preferred embodiment of the present invention, and in which:

FIGS. 1a and 1b are cross-sectional views of a first extrusion profile known in the prior art in as-designed and as-extruded conditions;

FIG. 2 is a cross-sectional view of an extrusion profile in accordance with the present invention;

FIG. 3 is a perspective view of a triangular support structure for use with an extruded profile;

FIG. 4 is a schematic illustration of an apparatus for an extrusion process in accordance with the present invention;

FIG. 5 is a cross-sectional view of a die element of the apparatus of FIG. 4;

FIGS. 6a and 6b are cross-sectional views of another embodiment of a known extrusion profile shown in as-designed and as-extruded conditions;

FIG. 7 is a cross-sectional view of another embodiment of an extrusion profile in accordance with the present invention;

FIGS. 8a and 8b are cross-sectional views of another embodiment of a known extrusion profile shown in as-designed and as-extruded conditions;

FIG. 9 is a cross-sectional view of another embodiment of an extrusion profile in accordance with the present invention;

FIG. 10 is a perspective view of a portion of a length of the extrusion profile of FIG. 9 shown in combination with an external attachment member;

FIG. 11 is a cross-sectional view of the extrusion profile and attachment member of FIG. 10 taken along the lines 11-11;

FIG. 12 is a partially exploded perspective view of two lengths of the extrusion profile of FIG. 9 assembled together;

FIG. 13 is a side view of the assembled extrusion profiles of FIG. 12;

FIG. 14 is an enlarged view of the combination of FIG. 11;

FIG. 15 is an enlarged view of a portion of the assembly of FIG. 13 shown from a reverse angle and with one profile in phantom;

FIG. 16 is an enlarged portion of the extrusion profile of FIG. 1;

FIG. 17 is an enlarged portion of the extrusion profile of FIG. 2;

FIG. 18 is a cross-sectional view of a portion of another embodiment of an extrusion profile with a support structure in accordance with the present invention; and

FIG. 19 is an enlarged cross-sectional view of the second length element of the extrusion profile shown in FIG. 12.

### DETAILED DESCRIPTION OF THE INVENTION

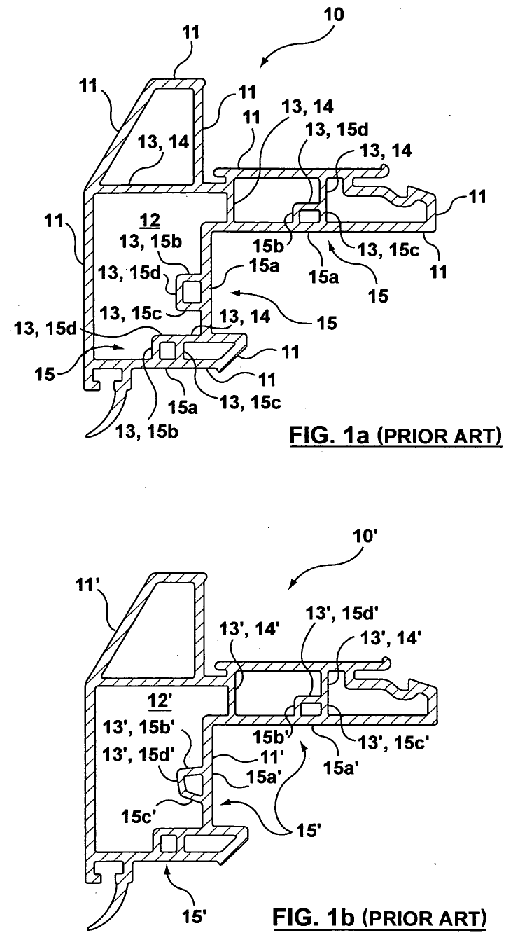

FIG. 1a shows a first known extrusion profile 10 in an as-designed condition. The extrusion profile 10 is a window lineal, constructed of an appropriate extrudable material such as PVC. The profile 10 has a number of exterior wall portions 11 that form, in cross-section, a generally enclosed polygonal interior space 12. The profile 10 also has a number of interior walls 13 provided within the interior space 12. Some of the interior walls 13 are in the form of reinforcing webs 14 that extend orthogonally between two opposed exterior wall portions 11, between other interior walls 13, or between a combination of interior and exterior walls 13, 11.

Some of the interior walls 13 are configured to form screw bosses 15. The screw bosses 15 are generally square in cross-section in the illustrated embodiment, having four orthogonal walls 15a-15d. A first base wall 15a is provided by a portion of one of the exterior wall portions 11 located adjacent the screw boss 15. Opposed sidewalls 15b and 15c extend perpendicularly from the base wall 15a. A top wall 15d extends between the sidewalls 15b and 15c, parallel to and spaced away from the base wall 15a. In some screw bosses 15, one or more of the walls 15b, 15c, and 15d may also form part or all of a reinforcing web 14 or of an exterior wall portion 11 of the profile 10.

The inventors have observed that in known extrusion profiles, the as-designed cross-section of the profile is often not accurately obtained in an actual manufactured profile. For example, the interior walls providing support webs and/or screw bosses are often distorted in known extruded profiles.

Referring now to FIG. 1b, the profile 10 from FIG. 1a is shown in a typical as-manufactured condition (as opposed to the as-designed condition) and denoted by reference character 10′ to distinguish from the as-designed profile 10. Profile 10′ has the same features as profile 10 identified by like reference characters, with a prime suffix added for distinction.

In the extruded profile 10′, a number of interior walls 13′ forming the screw bosses 15′ are distorted in comparison to the corresponding “theoretical” features 13, 15 in the as-designed profile 10. The walls 15b′, 15c′ and 15d′, particularly where separate from any reinforcing webs 14′, are twisted and inclined away from the orthogonal position of the corresponding walls 15b, 15c, and 15d in the profile 10.

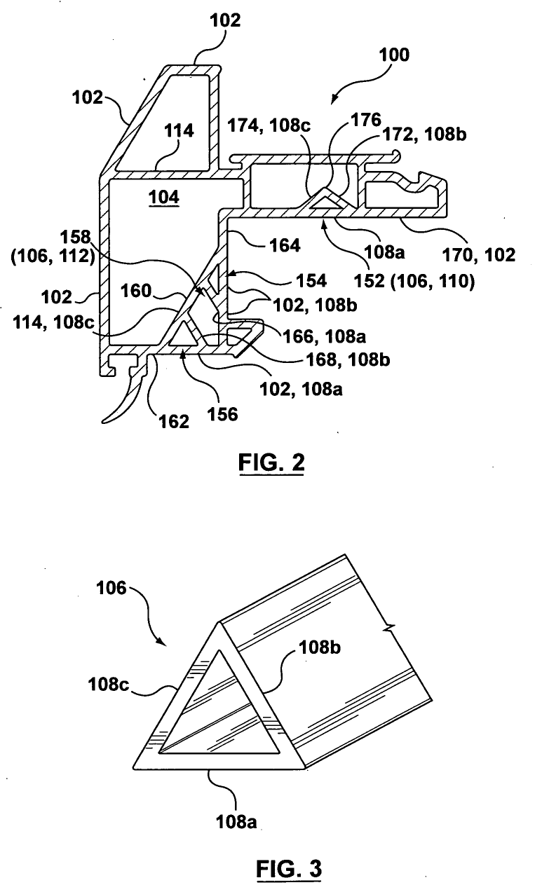

An extrusion profile 100 similar to the profiles of FIGS. 1a and 1b, but in accordance with the present invention, is shown generally in FIG. 2. The extrusion profile 100 has exterior wall portions 102 that, in the embodiment illustrated, are configured similarly to the exterior wall portions 11 of the extrusion 10, and form in cross-section a generally enclosed polygonal interior space 104.

The extrusion profile 100 is further provided with at least one triangular support structure 106 secured within the interior space 104. The triangular support structures 106 can serve a number of functions, such as, for example, but not limited to, increasing the strength and rigidity of the profile 100, and providing a screw boss for anchoring screws.

Referring now to FIG. 3, the triangular support structure 106 has, in the embodiment illustrated, three support walls, namely support wall 108a, support wall 108b, and support wall 108c. The support walls 108a, 108b, and 108c can be arranged to form, for example, but not limited to, an equilateral triangle, an isosceles triangle, or a right-angled triangle. The triangular support structure need not be a “true” triangle, but can also take the form of other triangle-based shapes such as, for example, a truncated triangular or trapezoidal shape.

The triangular support structure 106 can be of an extruded PVC material, and can be formed integrally within a larger extrusion profile in which the support structure 106 is provided.

Referring again to FIG. 2, the extrusion profile 100 is provided with, in the embodiment illustrated, three triangular support structures 106 adapted to serve primarily as screw bosses 110, and one relatively larger triangular support structure 106 adapted to serve primarily as a reinforcement 112 for the profile 100. For clarity, the smaller three support structures 106 serving as screw bosses 110 have been identified with unique reference characters 152, 154, and 156. The larger support structure 106 serving primarily as reinforcement has been identified with reference character 158.

The support walls 108a, 108b, and 108c of the triangular support structures 106 of the profile 100 are, in the embodiment illustrated, generally formed of the exterior walls 102 (or portions thereof), and interior walls 114 (or portions thereof) extending from inner surfaces of the exterior walls 102.

In particular, the larger support structure 158 has support walls 108a, 108b, and 108c that form a triangular shape in cross-section. The support walls 108a and 108b of the support structure 158 are, respectively, portions of particular exterior walls 162 and 164, which are generally orthogonal to each other. The support wall 108c of the support structure 158 is formed by a particular interior wall 160, which extends obliquely between the exterior walls 162 and 164.

In the embodiment illustrated, it can be seen that a support structure 106 can itself have interior walls 114 to form further triangular support structures. In particular, two of the smaller support structures 106, namely support structures 154 and 156, are positioned generally within the larger support structure 158. The support structure 154 has support walls 108a, 108b, and 108c defined by, respectively, (i) an interior wall 166 extending between the exterior wall 164 and the interior wall 160, (ii) a segment of the exterior wall 164, and (iii) a segment of the interior wall 160. The support structure 156 has support walls 108a, 108b, and 108c defined by, respectively, (i) a segment of the exterior wall 162, (ii) an interior wall 168 extending between the exterior wall 162 and the interior wall 160, and (iii) a segment of the interior wall 160.

The third of the smaller support structures 106 of the extrusion 100, namely, support structure 152, also has walls 108a, 108b, and 108c defined by, respectively, (i) a portion of an exterior wall 170, (ii) an interior wall 172 extending obliquely from an inner surface of the of the exterior wall 170, and (iii) an interior wall 174 extending between the interior wall 172 and the exterior wall 170. The interior walls 172 and 174 adjoin or intersect each other at apex 176. In the embodiment illustrated, the interior walls 172 and 176 terminate at the apex 176, and the apex 176 is spaced apart from any other exterior walls 102 or interior walls 114.

The triangular support structures 106 can improve the load-bearing capacity of the extrusion 100 when in use. The support walls (or legs) 108a, 108b, 108c of the triangular support structures 106 can better distribute forces exerted on the extrusion 100 so that distortion, deflection, or failure of the extrusion can be reduced and/or avoided. Forces can be exerted on the extrusion 100 and support structures 106 by, for example, but not limited to, wind loads or screw fasteners. The inventors believe that the support walls 108a, 108b, and 108c can act like a truss, distributing forces more evenly across more stable members (such as exterior walls 102) so that the strength and rigidity of the overall structure can be increased. The force distributing aspect of the support structure 106 will be described in further detail hereinafter.

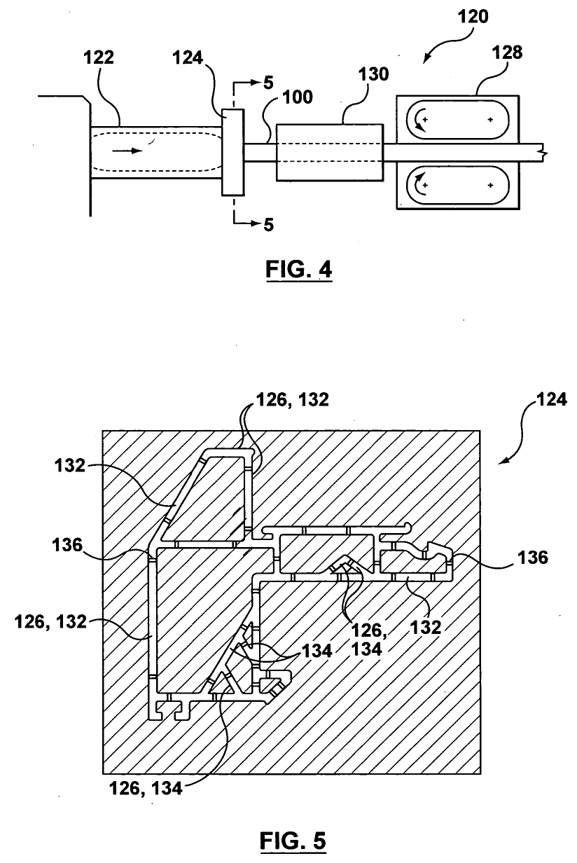

The triangular support structures can also facilitate manufacturing the extrusion 100. Referring now to FIG. 4, a schematic drawing of an extrusion apparatus 120 is shown. The apparatus includes an extruder 122 and a primary forming die 124. The extruder 122 forces liquefied plastic through the die 124, which has apertures (also called extrusion slots) 126 corresponding to the shape of the desired extrusion. A puller 128 can be provided downstream of the die 124, and a vacuum sizer 130 can be provided between the die 124 and the puller 128.

As best seen in FIG. 5, the die 124 for producing the extrusion 100 has extrusion slots 126 including peripheral slots 132 for forming the external walls 102 of the profile, and internal slots 134 for forming the interior walls 114 of the profile 100. At least some of the internal slots 134 are configured, in relation to each other or to the external slots 132, to define a group of adjoining slots arranged in a generally triangular configuration for producing the generally triangular support structures 106 within the extruded profile 100. The die 124 need not have the exact shape of the profile 100, but can be dimensioned to compensate for downstream processing, such as, for example, but not limited to, stretching of the profile 100 by the puller 128.

In the embodiment illustrated, the extrusion slots 126 are generally straight, having straight, flat sidewalls extending between ends thereof, and adjoin each other end-to-end. In the embodiment illustrated, the slots 132, 134 are interrupted at points along their lengths with connector segments 136 for holding the die 124 together. As the semi-liquid plastic is forced through the extrusion slots 126 of the die 124, the plastic flows around the connector segments 136, rejoining into a single, monolithic structure downstream of the connector segments 136.

Once the extruded material is downstream of the connector segments 136, the material is generally subjected to distortion forces that urge various wall elements of the profile 100 to deviate from the as-designed profile. The distortion forces can include the force of gravity acting on the mass (i.e. the weight) of the various wall sections. The wall sections of the profile, particularly before completely solidifying, can generally bear some loading but are vulnerable to being pulled out of their desired portion relatively easily. Furthermore, the distortion forces can also be generated by thermal effects as the extruded profile 100 is cooled when exiting the die 124.

The provision of the vacuum sizer 130 can counteract some of the distortion forces. The vacuum sizer 130 is, in general terms, a hollow die having an inner surface that is adapted to nest around the outer surface of the exterior wall portions 102 in the as-designed condition. As the extrusion material passes through the sizer 130, suction is applied through the walls of the vacuum sizer, urging the exterior walls 102 of the profile 100 flush against the inner surface of the vacuum sizer 130. The extrusion material can also be cooled as it passes through the vacuum sizer 130, to “freeze” the exterior walls 102 in the desired, as-designed position. The vacuum sizer cannot, however, guide or control the interior walls 114 of the extrusion profile 100 to the as-designed position. The interior walls 114 are therefore particularly vulnerable to distortion forces.

By providing an extrusion profile with the triangular support structure 106, the profile 100 can better withstand these distortion forces associated with the extrusion process, resulting in an improved extrusion process. Improvements in the process can include, for example, better part quality or more accurately shaped profiles, resulting in fewer product rejections by the customer and lower scrap costs. Improvements in the process can also include the ability to run the process at higher extrusion speeds, resulting in reduced production costs. Furthermore, in some embodiments, the improved process can include eliminating the need for the vacuum sizer in some profiles where, without the triangular support structure 106, a vacuum sizer would generally otherwise be required.

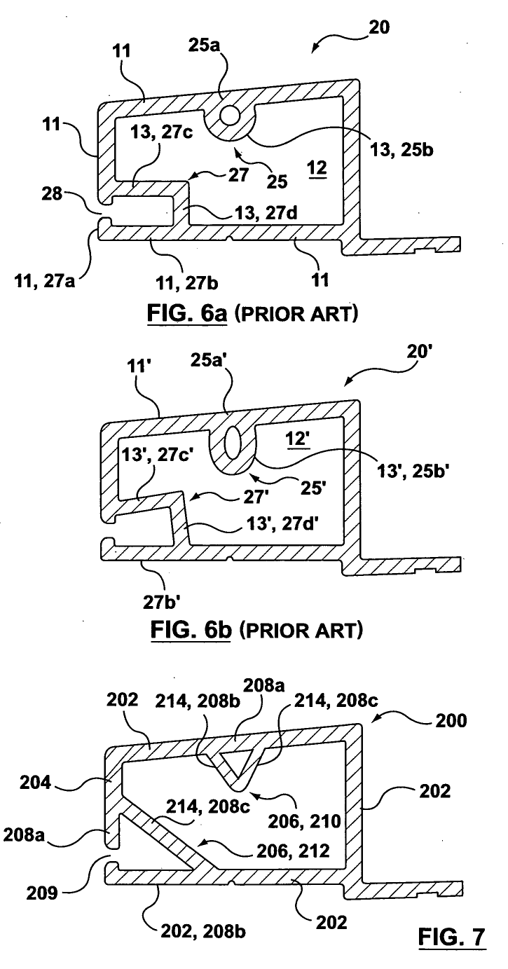

Another known profile is seen in an as-designed profile 20 in FIG. 6a, and as-extruded profile 20′ in FIG. 6b. The profile 20 has a screw boss 25 that is similar to screw boss 15 but has a circular, rather than a square, shape in cross-section. The screw boss 25 has opposed curved segments 25a and 25b. The segment 25a is substantially part of one of the exterior walls 11, and the segment 25b is an interior wall 13 extending in a curve between two points on the interior surface of the wall 11. When extruded, the screw boss 25′ in the profile 20′ can distort into, for example, an oval shape (FIG. 6b).

The profile 20 of FIGS. 6a and 6b also is referenced to understand another embodiment of this invention. The profile 20 is provided with a generally rectangular structure 27 which, in the embodiment illustrated, can reinforce an area of the profile 20 around a slot 28 provided in one of the exterior walls 11. The slot 28 can be used, for example, to attach accessory elements to the extruded profile in a snap-fit arrangement. In the embodiment illustrated, the rectangular support structure 27 includes two generally orthogonal webs 27c and 27d, each extending from respective orthogonal exterior walls 11 adjacent the slot 28.

As seen in FIG. 6b, the structure 27 around the slot 28 can also become distorted in the as-extruded profile 20′. This distortion can cause several problems, including, for example, interference with tongue elements designed to snap-fit into the groove 28.

An improved extrusion profile 200 that generally corresponds to the profile 20, 20′ but is made in accordance with the present invention can be seen in FIG. 7. The profile 200 has similar features to that of the profile 100, identified by like reference characters incremented by 100.

A first triangular support structure 206 serves as a screw boss 210 to replace the circular screw boss 25. Furthermore, a single inclined web 214, 208c replaces the orthogonal webs 27c and 27d, and forms another triangular support structure 206 in the form of a slot reinforcement 212. The slot reinforcement 212 has generally orthogonal walls 208a and 208b, connected by the oblique interior wall 208c. The wall 208a has a slot 209. The wall 208c bridges across the slot 209 to provide structural integrity to the area of the extrusion 200 around the slot 209.

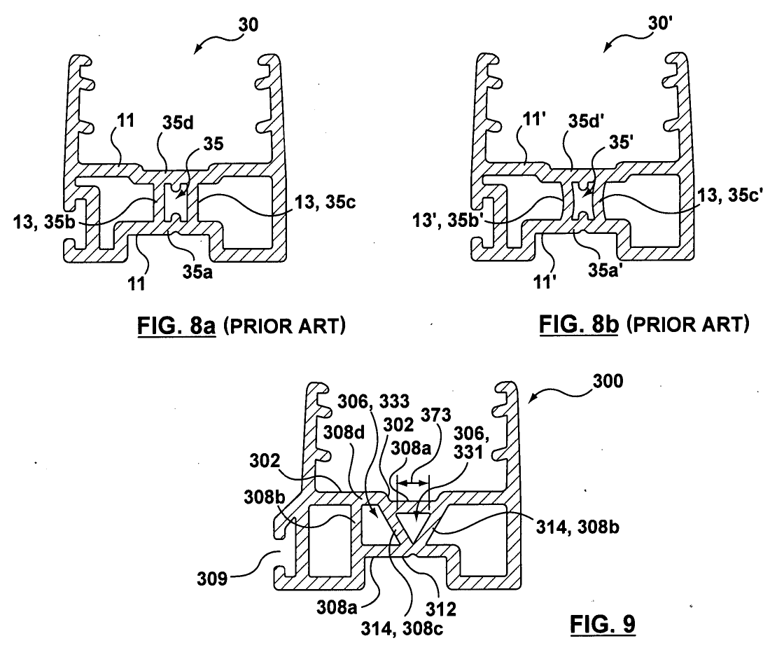

A third known extrusion profile is seen in an as-designed profile 30 in FIG. 8a, and as-extruded profile 30′ in FIG. 8b. The profile 30 has a screw boss 35 with a base wall 35a and a top wall 35d that each form part of opposing exterior walls 11. This configuration can assist in reducing distortion of the corresponding as-extruded walls 35a′ and 35d′ of the profile 30′. However, the interior sidewalls 35b and 35c are still subject to distortion, such as inwardly bowed walls 35b′ and 35c′ in the profile 30′.

Referring now to FIG. 9, another embodiment of an extrusion profile 300 in accordance with the present invention is shaped to generally correspond to the profile 30, 30′. The profile 300 has similar features to that of the profile 100, identified by like reference characters incremented by 200.

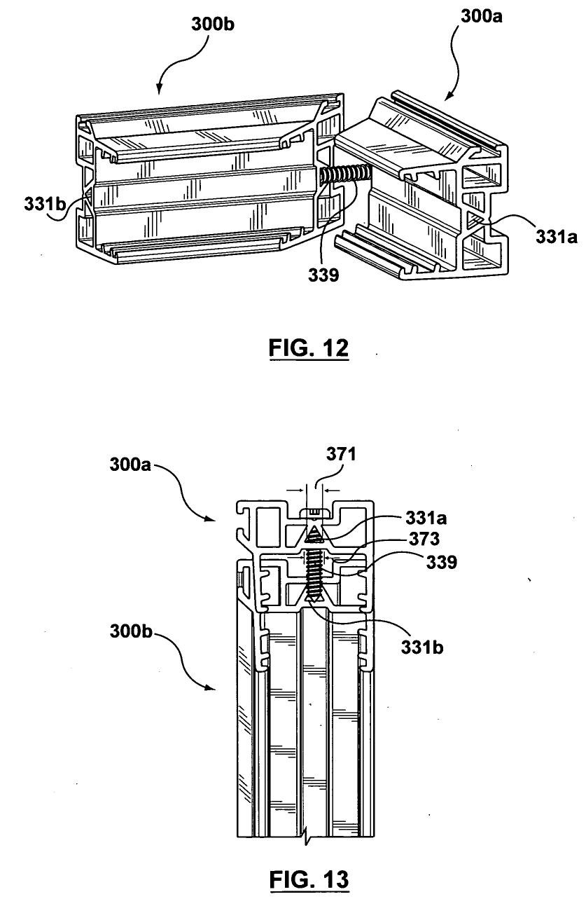

The profile 300 is provided with two triangular support structures 306, identified at 331 and 333 for clarity. The first support structure 331 serves primarily as a screw boss 310, and is generally formed by inclined (or oblique) interior walls 308b and 308c extending between generally parallel exterior wall portions 302. The first support structure 331 can be sized to facilitate anchoring a fastener such as a screw 339 (FIGS. 12 and 13) having a thread diameter 371.

In the embodiment illustrated, the support wall 308a defines a base wall and has a width 373 (FIG. 9) that extends between the oblique support walls 308b and 308c at their greatest separation. The width 373 of the base wall 308a can be greater than the diameter 371 of the fastener 339, to facilitate installation of the screw 339, and can be narrow enough so that at least a major portion of the axial length of the screw 339 extending across the support structure 331 can engage (and/or bite into) the converging oblique support walls 308b and 308c. A width 373 less than twice the diameter 371 of the screw 339 can be satisfactory in most cases. In the embodiment illustrated, the width 373 is greater than the diameter 371 by a factor in a range of about 1.2 to 1.3.

The second support structure 333 is provided adjacent the first support structure 331, and shares the interior wall 308c in common with the first support structure 331. The second support structure 333 is further provided with an interior wall 308b that extends generally orthogonally between the parallel exterior wall portions 302. The oblique interior walls 308b and 308c of the second support structure 333 converge but do not intersect, and are connected at their narrowest spacing by a support wall 308d. The support wall 308d is, in the illustrated embodiment, generally parallel to, and about one third the length (in cross-section) of, the support wall 308a. This provides the second support structure with a shape of a truncated right angled triangle in cross-section.

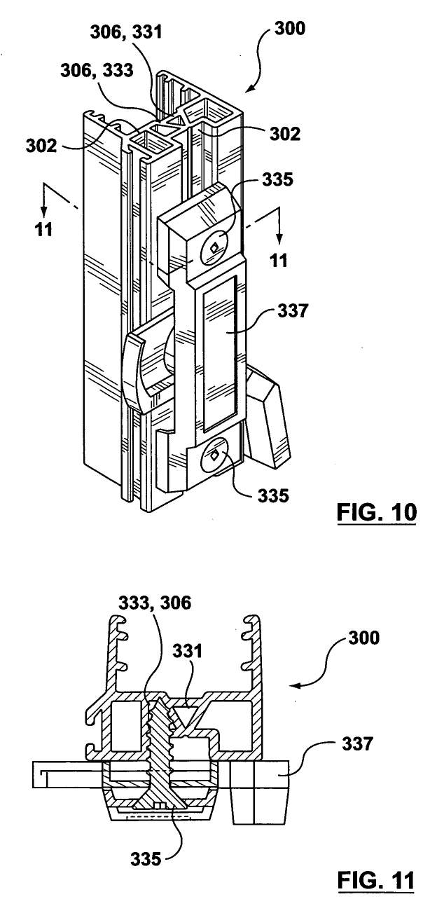

The second support structure 333 can function as a reinforcement 312 to reinforce the profile 300 in, for example, but not limited to, an area where an accessory slot 309 is provided. Furthermore, as best seen in FIGS. 10 and 11, the second support structure 333 can also function as a screw boss 306. In the embodiment illustrated, the second support structure 333 is used to anchor screws 335 for securing an element 337 to the profile 300.

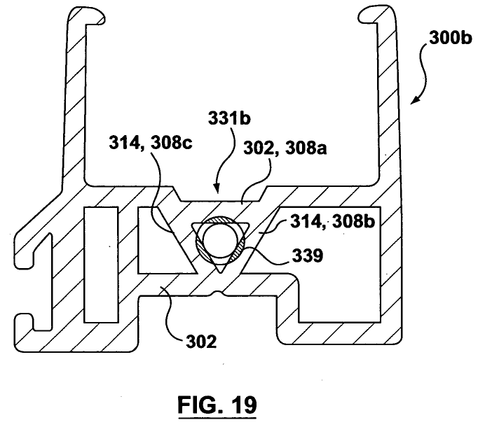

Referring now to FIGS. 12 and 13, the use of the first support structure 331 as a screw boss 306 can be seen. In the illustrated embodiment, the support structure 339 is used to fasten together two lengths of the extruded profile 300. The screw 339 extends generally transversely through the support structure 331a of a first length 300a of the profile 300, and then extends longitudinally along a portion of the length of the hollow interior of the support structure 331b of the second length 300b of the profile 300 (see also FIG. 19).

As mentioned previously, the inventors believe that the support structures 106, 206, 306 according to the present invention can have improved load bearing capacity for withstanding loads such as the distortional forces described previously. This improved load bearing capacity can result from the ability of the support structures 106, 206, 306 to distribute forces exerted at an apex of the support structure 106, 206, 306 along the walls 108, 208, 308 to adjacent structural members of, for example, a window lineal extrusion 100, 200, 300. A wall member of an extrusion profile is generally weakest (in terms of being able to resist an applied force) in a direction transverse to the wall member. By providing inclined support walls, at least some portion of an applied load will be transferred as a component in the plane of one or more wall members, thereby increasing the overall ability of an extrusion profile having a support structure 106, 206, 306 to withstand the load.

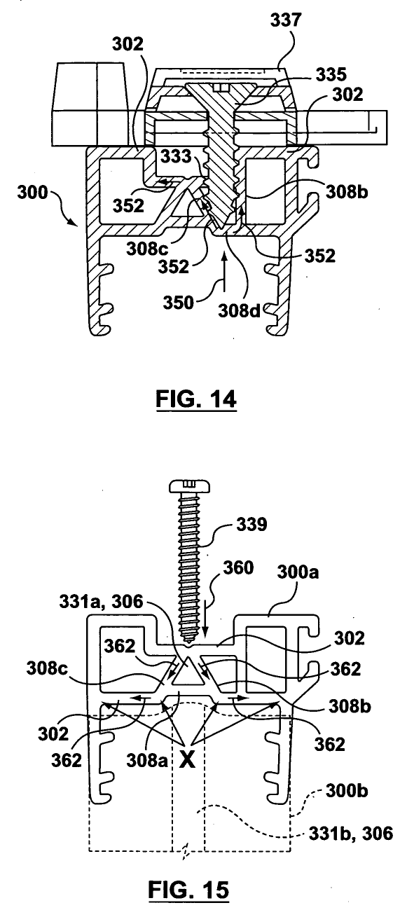

For example, and with reference now to FIG. 14, the screw 335 for securing the element 335 to the extrusion 300 can exert a compressive force identified by arrow 350. The force 350 acts generally opposite to the direction that the screw 335 is pointing. The force 350 will be distributed along each of the support walls 308b and 308c towards an exterior wall 302. The distributed force components are identified by arrows 352.

Another example can be seen in FIG. 15. The screw 339 for connecting extrusion lengths 300a and 300b exerts a compressive force 360 that acts generally in the same direction that the screw 339 is pointing. The force 360 will be distributed along the support walls 308b and 308c of the support structure 331a, 306 towards exterior wall 302. The distributed force components of the force 360 are identified at arrows 362.

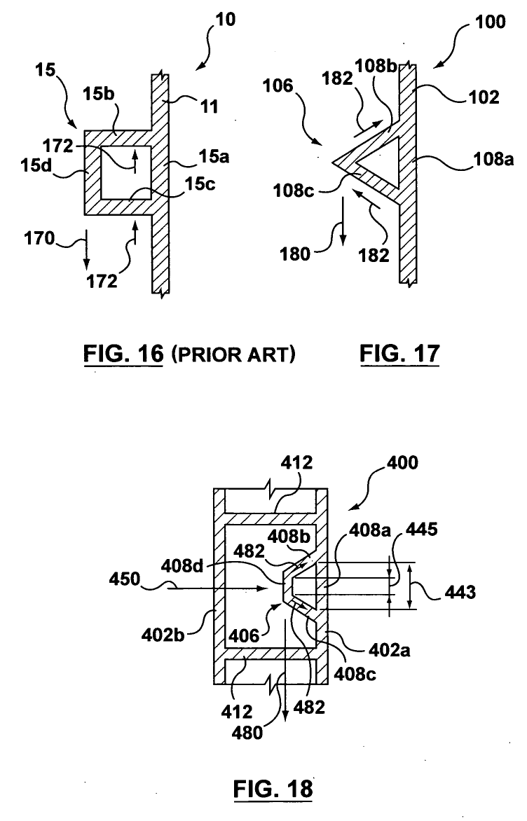

The force distribution aspect of the present invention can further be explained with reference to FIGS. 16 and 17. FIG. 16 shows a portion of the prior art extrusion profile 10 in a semi-solid state, just after leaving a forming die for extruding the profile 10. A force 170, such as gravity, is shown acting on the screw boss 15. The walls 15b and 15c are relied on to resist the force 170. But the walls 15b and 15c are transverse to the force 170, which is the weakest orientation for load bearing by the walls 15b and 15c. As a result, particularly when in a semi-solid state, the force 170 can distort the shape of the screw boss 15 in the as-extruded condition of profile 10. Furthermore, the provision of the wall 15d, having a length (in cross-section) that is generally equal to the length of the wall 15a, provides additional mass that is spaced away from the wall 15a and is generally supported by the walls 15b and 15c in a cantilevered fashion. This additional mass can result in an increased force 170 (for example, when the force 170 is due to gravity), which can exacerbate the possibility of distortion of the as-extruded profile 10.

In contrast, as seen in FIG. 17, the support structure 106 of the extrusion profile 100 is better able to withstand the force of gravity 180. The force of gravity 180 is resolved into components with respect to the support walls 108b and 108c, so that a component (force 182) of the force 180 acts in the plane of the walls 108b and 108c. The shape of the support structure 106 is therefore less susceptible to distortion. As well, the converging nature of the support walls 108b and 108c reduces the overall mass that is suspended away from the exterior wall 102, which reduces the magnitude of the force 180 and can further reduce distortion of the boss 106.

By distributing an applied force 350, 360 along at least one inclined support wall, the force 350, 360 can be divided into distributed forces having components both parallel and perpendicular to the applied force 350, 360. This can transfer at least part of the load from a direction acting perpendicular to a wall of an extrusion, to a direction that is parallel to the wall of an extrusion. Accordingly, the inventors believe that the support structures 106, 206, 306 of the present invention can transfer at least part of a transversely applied load from the transverse direction to a coplanar direction, relative to wall members of the extrusion.

A further embodiment of an extrusion profile 400 is best seen in FIG. 18. The extrusion profile 400 has two generally parallel exterior walls 402a and 402b, with a support structure 406 extending from one exterior wall 402a, towards the opposite exterior wall 402b. The support structure 406 has the shape of a truncated triangle. In particular, the support structure 406 has a first support wall 408a defined by a portion of the exterior wall 402a, and having a width 443. The width 443 generally denotes the linear extent of the wall 408a as viewed in cross-section. The support structure 406 further has second and third support walls 408b and 408c extending obliquely from the first support wall 408a, at either end of the width 443. The second and third support walls 408b and 408c converge with increasing distance from the first support wall 408a, but do not intersect. Rather, the support walls 408b and 408c extend to a fourth support wall 408d, which, in the embodiment illustrated, extends generally parallel to the support wall 408a. The support wall 408d has a width 445 that is less than the width 443 of the support wall 408a. In the embodiment illustrated, the width 445 of the support wall 408d is about one half the width 443 of the support wall 408a.

As further seen in FIG. 18, the support structure 406, although not a true triangle, can nevertheless provide at least some of the force distributing properties and associated benefits as compared to completely triangular shaped support structures. For example, a force 450 or a force 480 applied to the support structure 406 can be resolved into component forces with at least some force 482 being distributed in the plane of the oblique support walls 408b and 408c, which in turn provides increased load bearing capacity (and distortion resistance capacity) of the support structure 406 as compared to prior art support structures.

In the support structures 106, 206, 306, 406, the hollow interior defined by the respective support walls 108, 208, 308, 408 can be sized so that the inner surfaces of the support walls are tangent to a circumscribed circle having a diameter that is less than the outer diameter of a fastener to be inserted into the support structure 106, 206, 306, 406. For example, as best seen in FIG. 19, the hollow interior of the support structure 331b of the length 300b of the profile 300 is sized smaller than the outer diameter of the threads of the screw 339. In other words, the walls 308a, 308b, and 308c are positioned sufficiently close together so that the screw 339 can bite into the walls 308 and provide good thread engagement to anchor the screws 339.

It is to be understood that what has been described are preferred embodiments of the invention. The invention nonetheless is susceptible to certain changes and alternative embodiments without departing from the scope of the subject invention.

1. An extrusion profile, comprising at least one internal support structure having at least three generally planar support walls connected to each other, at least two of said support walls aligned in a converging orientation to form a generally triangular shape in cross-section.

2. The extrusion profile of claim 1 further comprising exterior walls enclosing a generally polygonal interior space, and interior walls extending from inwardly directed surfaces of the exterior walls.

3. The extrusion profile of claim 2, wherein the support walls of the internal support structure comprise at least a portion of at least one of the interior walls.

4. The extrusion profile of claim 3, wherein the support walls of the internal support structure comprise at least a portion of at least one of the exterior walls.

5. The extrusion profile of claim 1, wherein the internal support structure is adapted to anchor a screw, at least one of the support walls having a width greater than the diameter of the screw but less than twice the diameter of the screw.

6. The extrusion profile of claim 1 wherein the support walls circumscribe an anchoring diameter that is less than the diameter of a screw to be anchored in the support structure.

7. The extrusion profile of claim 1 wherein the support structure comprises three support walls.

8. The extrusion profile of claim 7 wherein two of the support walls are connected at an apex that is spaced apart from any other of the interior and exterior walls.

9. The extrusion profile of claim 8 wherein one of the support walls comprises a portion of one of the external walls.

10. A die for extruding an extrusion profile, comprising:
a) a plurality of generally straight extrusion slots including peripheral slots and internal slots;
b) the peripheral slot adjoining each other end-to-end to form a generally polygonal shape in cross-section;
c) the internal slots disposed generally within the polygonal shape; and
d) at least one of the internal slots adjoining at least two other ones of the extrusion slots and being obliquely oriented relative thereto to form a generally triangular shape in cross-section.

11. The die of claim 9 wherein the group of slots comprises two internal slots each having respective first and second ends, the two internal slots converging towards each other from a wider spacing between the first ends to a narrower spacing between the second ends, each of the respective first ends adjoining at least one of the peripheral slots.

12. The die of claim 10, wherein the respective first ends of the two internal slots adjoin a single one of the peripheral slots.

13. The die of claim 11, wherein at least one of the two internal slots is obliquely oriented relative to the single one of the peripheral slots.

14. A method of manufacturing an extrusion profile, comprising:
a) extruding a liquified plastic through a die, the die having a plurality of extrusion slots for forming adjoining walls of the extrusion profile, the walls including exterior walls and interior support walls, at least one of the interior walls and at least two other ones of the support walls being oriented to provide an internal support structure being generally triangular in cross-section.

15. The method of claim 11, comprising passing the extrusion through a vacuum sizer upon exiting the die, the vacuum sizer applying a laterally outward pulling force on the exterior walls to achieve a desired shape, the internal support structure distributing the pulling force along at least said at least one interior support wall to limit distortion of the extrusion.

16. The method of claim 15, wherein the support structure comprises at least two interior walls, each of which are obliquely oriented relative to the pulling forces so that the pulling forces are resolved into components, at least one of the components being parallel to a width dimension of the at least two interior walls.
